(19) United States
(12) Patent Application Publication
(10) Pub. No.: US 2024/0419297 A1
(43) Pub. Date: Dec. 19, 2024

(54) INTERFACE DISPLAY METHOD AND APPARATUS, DEVICE, STORAGE MEDIUM, AND PROGRAM PRODUCT

(71) Applicant: GUANGDONG OPPO MOBILE TELECOMMUNICATIONS CORP., LTD., Dongguan (CN)

(72) Inventors: Zhaojin WANG, Dongguan (CN); Pengbo Zhao, Dongguan (CN); Haiyun Tang, Dongguan (CN); Long Chen, Dongguan (CN); Ansheng Ma, Dongguan (CN)

(73) Assignee: GUANGDONG OPPO MOBILE TELECOMMUNICATIONS CORP., LTD., Dongguan (CN)

(21) Appl. No.: 18/750,446

(22) Filed: Jun. 21, 2024

Related U.S. Application Data
(63) Continuation of application No. PCT/CN2022/130385, filed on Nov. 7, 2022.

(30) Foreign Application Priority Data
Dec. 23, 2021 (CN) 202111590043.6

(51) Int. Cl. G06F 3/0482; G06F 9/451

(52) U.S. Cl. CPC G06F 3/0482; G06F 9/451

(57) ABSTRACT

An interface display method is applicable to an electronic device, and the electronic device supports running of a first system and a second system. The method includes: displaying, by the first system, an application list interface in response to a list starting operation, where the application list interface includes an application run by the first system and an application run by the second system; sending, by the first system, an application starting message to the second system in response to a selection operation of a first application in the application list interface, where the first application is run by the second system; and starting, by the second system, the first application and displaying, by the second system, an application interface based on the application starting message. An electronic device and a non-transitory computer-readable storage medium are also provided.

### CROSS REFERENCE TO RELATED APPLICATIONS

The present application is a continuation-application of International (PCT) Patent Application No. PCT/CN2022/130385, filed Nov. 7, 2022, which claims foreign priority to Chinese Patent Application No. 202111590043.6, filed Dec. 23, 2021, both of which are herein incorporated by reference in their entirety.

### TECHNICAL FIELD

The present disclosure relates to the field of electronic devices, and in particular to an interface display method, an electronic device, and a non-transitory computer-readable storage medium.

### BACKGROUND

With the continuous development of science and technology, more and more electronic devices with different functions emerge at the historic moment, which brings many conveniences to a user's daily life.

In addition to some simple functions, such as checking time and setting alarm clock, the electronic device may also achieve some complex functions through an installed application. For example, a user may communicate instantly through an instant messaging application installed in the electronic device, and monitor sleep quality in real time through a sleep-monitoring application installed in the electronic device.

### Summary of the Present Disclosure

According to a first aspect, some embodiments of the present disclosure provide an interface display method. The method is applicable to an electronic device, and the electronic device supports running of a first system and a second system. The method includes: displaying, by the first system, an application list interface in response to a list starting operation, where the application list interface includes an application run by the first system and an application run by the second system; sending, by the first system, an application starting message to the second system in response to a selection operation of a first application in the application list interface, where the first application is run by the second system; and starting, by the second system, the first application and displaying, by the second system, an application interface based on the application starting message.

According to a second aspect, some embodiments of the present disclosure provide an electronic device. The electronic device includes a processor and a memory. The processor at least includes a first processor and a second processor, power consumption of the second processor is higher than that of the first processor. The memory stores at least one program, and the at least one program is configured to be execute by the processor to perform the interface display method described in the foregoing aspect.

According to a third aspect, some embodiments of the present disclosure provide a non-transitory computer-readable storage medium. The storage medium stores at least one program, and the at least one program is configured to be execute by a processor to perform the interface display method described in the foregoing aspect.

### BRIEF DESCRIPTION OF THE DRAWINGS

FIG. 1 is a schematic diagram of a dual-core communication software framework corresponding to a second processor according to an embodiment of the present disclosure.

FIG. 2 is a schematic diagram of a dual-core communication software framework corresponding to a first processor according to an embodiment of the present disclosure.

FIG. 3 is a flowchart of an interface display method according to an embodiment of the present disclosure.

FIG. 4 is a schematic diagram of an interface in an interface switching process of a smartwatch according to an embodiment of the present disclosure.

FIG. 5 is a schematic diagram of an interface in an application layout editing process according to an embodiment of the present disclosure.

FIG. 6 is a schematic diagram of an interface in an application deletion process according to an embodiment of the present disclosure.

FIG. 7 is a sequence diagram of an interaction between systems in an application uninstallation process according to an embodiment of the present disclosure.

FIG. 8 is a sequence diagram of an interaction between systems in an application installation process according to an embodiment of the present disclosure.

FIG. 9 is a sequence diagram of an interaction between systems under a first return operation according to an embodiment of the present disclosure.

FIG. 10 is a sequence diagram of an interaction between systems under a second return operation according to an embodiment of the present disclosure.

FIG. 11 is a structural block diagram of an interface display apparatus according to another embodiment of the present disclosure.

FIG. 12 is a structural block diagram of an electronic device according to another embodiment of the present disclosure.

### DETAILED DESCRIPTION

In order to make the purpose, technical solutions and advantages of the present disclosure clearer, the present disclosure will be further described in detail below with reference to the accompanying drawings.

In the present disclosure, the term “multiple” or “a plurality of” means two or more. The term “and/or” may illustrate an association relationship of associated objects, indicating that three relationships can exist. For example, A and/or B may indicate: the existence of A alone, the existence of both A and B, and the existence of B alone. In addition, the character “/” may generally indicate an “or” relationship between the former object and latter object.

In the related art, an electronic device is configured with a single processor that processes, by running an operating system on the processor, all system events generated during running of the device. Therefore, the processor needs to have a powerful data processing capability and remain in a working state during the running of the device. However, the electronic device only needs to realize some functions that require low processing performance in most cases in daily use. Taking a smartwatch or a smart wristband as examples, the smartwatch or the smart wristband only needs to perform a time display and message prompt in most cases. Therefore, the processor remaining in the working state for a long time does not improve the performance of the electronic device, but increases the power consumption of the device, resulting in a shorter battery life of the electronic device (especially on a wearable device with small battery capacity).

In order to reduce the power consumption of the electronic device while ensuring the performance of the electronic device, in a possible embodiment, the electronic device is configured with at least a first processor and a second processor that have different processing performances and power consumption. The first processor is configured to run the first system, and the second processor is configured to run the second system (namely, a dual-core dual system). A set of system switching mechanisms is designed for the dual-core dual-system.

During the running of the electronic device, the first system is run by a processor with low-power consumption to process an event that requires low processing performance, and a processor with high-power consumption remains in a sleep state (correspondingly, the second system ran by the processor with high-power consumption is in the sleep state), thus reducing power consumption of the electronic device while realizing a basic function of the electronic device. When an event that require high processing performance occurs (for example, when an application program is started), the processor with high-power consumption is woken up and the second system is switched to process the event, so as to ensure that a triggered event can be responded to and processed in time to satisfy a performance requirement of the electronic device.

In some embodiments of the present disclosure, the first system is not only responsible for displaying an application list interface, but also responsible for displaying a system main interface and an application run by the first system, so as to reduce frequent switching between systems. When a user selects the application run by the first system through the application list interface, the electronic device does not need to perform system switching, but continues to start the application through the first system and display the application interface. When the user selects an application run by the second system through the application list interface, the first system sends an application starting message to the second system, and the second system is switched to start the application and display the application interface.

Since the user may start the application run by the first system or the second system through the application list interface, the application list interface is displayed by the first system. In this way, it may be possible to ensure that the application run by the second system may be started normally. At the same time, it may be possible to reduce an occurrence of the frequent switching between systems when the user wants to start the application run by the first system and needs to switch to the second system to display the application list interface, thereby reducing the power consumption of the electronic device.

In some embodiments of the present disclosure, the first processor and the second processor work asynchronously, and the first system and the second system need to realize system communication (or referred to as dual-core communication). In a possible application scenario, the first system is a real-time operating system (RTOS) run by a micro control unit (MCU), and the second system is an Android operating system run by a central processing unit (CPU).

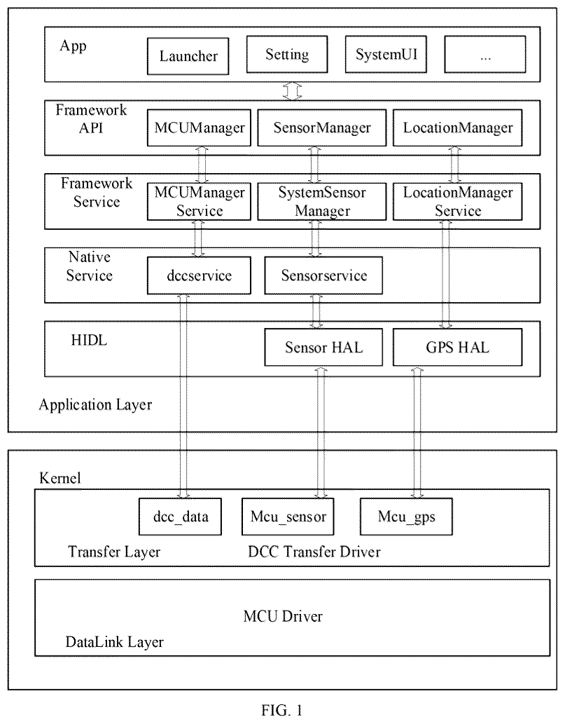

As illustrated in FIG. 1, FIG. 1 illustrates a dual-core communication software framework of the Android operating system according to some embodiments of the present disclosure. The dual-core communication software framework adheres to the design principles of “low coupling, high reliability, and high multiplexing”, and includes developments of a kernel module, a hardware abstraction layer interface definition language (HIDL) module, a native service module, a framework service module, a framework application programming interface (API) module, and an application (APP) module.

The APP module includes functional modules such as a launcher (desktop launcher), a setting, a system user interface (UI), or the like. The framework API module includes management modules such as an MCU manager, a sensor manager, a location manager, or the like. The framework service module includes service modules such as an MCU manager service, a system sensor manager, a location manager service, or the like. The native service module includes service modules such as a data call control service (dcc service), a sensor service, or the like. The HIDL module includes modules such as a sensor hardware abstraction layer (HAL), a global positioning system (GPS) HAL, or the like. The kernel module includes DCC transfer drivers such as dec_data, Mcu_sensor, Mcu_gps, or the like.

A transport layer serves as an interface layer connecting an upper layer and a lower layer in a dual-core communication software framework. The transport layer is configured to shield a transport detail of communication at the lower layer (a data link layer) of a system from an application layer and provide a service channel for an application scenario. The application layer, as a main provider of services, is configured to respond to human-computer interaction, transmit data generated during human-computer interaction through a transmission layer, and respond to an external data request.

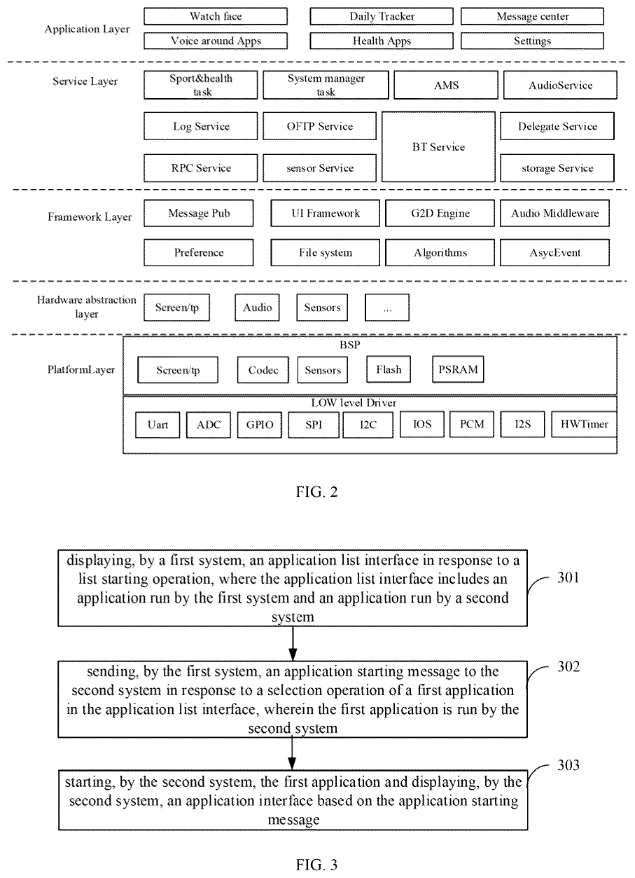

The RTOS is designed under the principle of equivalence. Taking the electronic device as a smartwatch as an example, as illustrated in FIG. 2, FIG. 2 illustrates a dual-core communication software framework of the RTOS according to some embodiments of the present disclosure.

The dual-core communication software framework of the RTOS is divided into an application layer, a service layer, a framework layer, a HAL, and a platform layer.

The application layer includes application modules such as a watch face, a daily tracker, a message center, voice around Apps, health Apps, settings, or the like. The service layer includes service modules such as a sport & health task, a system manager task, an activity management service (AMS), an audio service, a log service, an Odette file transfer protocol (OFTP) service, a Bluetooth (BT) service, a delegate service, a remote procedure call (RPC) service, a sensor service, a storage service, or the like. The framework layer includes framework modules such as a message pub, a UI framework, a graphics 2D (G2D) Engine, an audio middleware, a preference, a file system, algorithms, an AsycEvent, or the like. The HAL includes hardware abstraction modules such as a screen/touch panel (TP), sensors, or the like. The platform layer includes a board support package (BSP) and a low-level driver, where the BSP includes a screen/TP, a codec, sensors, a flash, a pseudo static random access memory (PSRAM), or the like; and the low-level driver includes a universal asynchronous receiver/transmitter (Uart), an analog-to-digital converter (ADC), a general purpose input/output (GPIO), a serial peripheral interface (SPI), an inter-integrated circuit (I2C), an input/output system (IOS), a pulse-code modulation (PCM), an inter-IC sound (I2S), and a hardware (HW) timer.

The foregoing dual-core communication software framework is only used for exemplary description, and a person skilled in the art may add, delete or modify the foregoing framework according to actual requirements. The present disclosure does not limit a specific structure of the dual-core communication software framework.

As illustrated in FIG. 3, FIG. 3 is a flowchart of an interface display method according to an embodiment of the present disclosure. In the embodiment, for example, the method is applicable to an electronic device that supports running of a first system and a second system. The method may include the following operations.

At block 301, in response to a list starting operation, the first system displays an application list interface. The application list interface includes an application run by the first system and an application run by the second system.

In some embodiments, operating power consumption of the first system is lower than that of the second system. Therefore, the electronic device tends to cause the first system to be keep in a wake-up state for a long time, while the second system is switched from a sleep state to the wake-up state only when it is necessary to handle a specific task.

In a possible embodiment, the electronic device is arranged with a first processor and a second processor. Processing performance of the first processor is lower than that of the second processor (both processing capacity and processing speed of the first processor are lower than those of the second processor), and power consumption of the first processor is lower than that of the second processor. Correspondingly, the second system (run by the second processor) is capable of processing an event processed by the first system (run by the first processor), and the first system may not be able to process the event processed by the second system.

In another possible embodiment, the electronic device may be arranged with a single processor. The first system and the second system are respectively run by different cores of the processor. The processing performance of a core running the second system is higher than processing performance of a core running the first system.

Taking the electronic device as a smartwatch as an example, the first processor is an MCU, the second processor is a CPU, the first system is a RTOS, and the second system is an Android system. Correspondingly, an event that may be processed by the first system includes scenarios requiring low processing performance or weak interaction scenarios, such as watch face display, watch-face interface switch, notification-and-message display, etc. An event that may be processed by the second system includes scenarios requiring high processing performance or strong interaction scenarios, such as incoming calls answering, replying to a message, watch-face editing, function setting, etc.

In a possible embodiment, a working mode of the electronic device may include a performance mode, a hybrid mode, or a low-power mode. In the performance mode, the second processor and the first processor both remain in the wake-up state (correspondingly, both the first system and the second system are in the wake-up state). In the low-power mode, only the first processor remains in the wake-up state, and the second processor is in an off state (that is, the first system is in the wake-up state, and the second system is in the off state). In the hybrid mode, the second processor is in a standby state and may switch between the sleep state and the wake-up state when the first system processes an event (that is, when the first system is in the wake-up state, the second system may be in the wake-up state or in the sleep state).

In some embodiments, in the wake-up state, system-related data is cached in a memory such as a random access memory (RAM) and can be run at any time. In the sleep state, most hardware modules of the processor are turned off, system-related data is stored in a hard disk such as a read-only memory (ROM), and the system-related data is written into the memory from the hard disk when the sleep state is switched to the wake-up state.

Unlike an electronic device with strong interaction such as a smartphone, the wearable device is an auxiliary electronic device and only has weak interactions with a user in most usage scenarios. For example, the user only raises their wrists to check the time or message prompt through the smartwatch in most scenarios. Therefore, the second processor is controlled to be in the sleep state (that is, the second system is controlled to be in the sleep state) to reduce overall power consumption of the wearable device when the wearable device processes the event by the first system. For convenience of description, the wearable device is taken as an example in the following embodiments.

The application list interface, which serves as an entry for the user to start the application, is frequently used during the running of the electronic device. In some embodiments of the present disclosure, the first system is responsible for rendering and displaying the application list interface, so as to reduce the operating power consumption of the electronic device. In addition, the first system is not only responsible for displaying the application list interface, but also responsible for displaying the system main interface and an application interface of the application run by the first system. When the electronic device is a smartwatch, the system main interface may be a watch-face interface.

In some embodiments, during a process where the first system displays the system main interface, the first system may switch the system main interface to the application list interface if the list starting operation is received. During a process where the first system runs the application, the first system may switch a currently displayed application interface to the application list interface if the list starting operation is received.

In some embodiments, during a process where the second system runs the application, if the list starting operation is received, the second system may be switched to the first system, and the application list interface is displayed by the first system.

The list starting operation may be a touch control operation (an operation on a touch display screen of the electronic device), a key-pressing operation (pressing a physical key of the electronic device), a voice operation, etc., which is not limited herein.

In some embodiments, the application in the application list interface may be displayed in a form of an icon and/or a text, which is not limited herein.

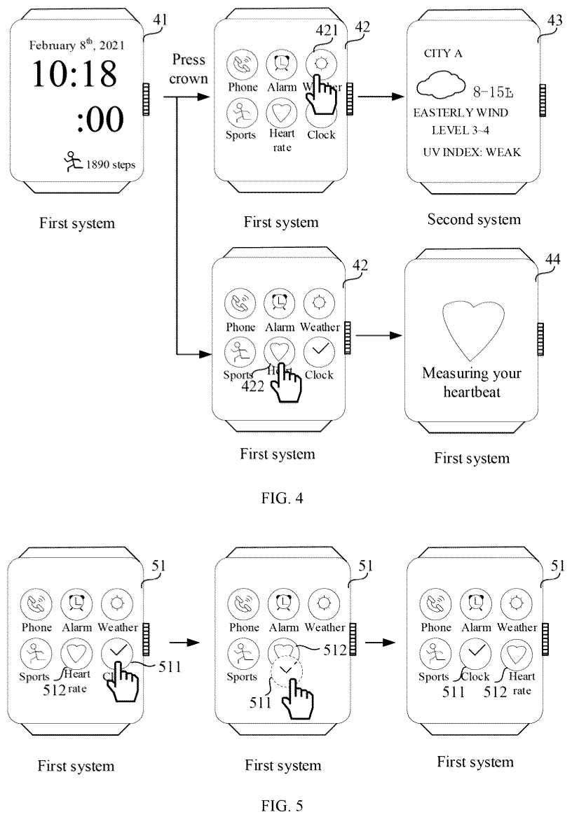

In some embodiments, as illustrated in FIG. 4, taking the electronic device as the smartwatch as an example, the first system currently displays a watch-face interface 41. When a pressing operation on a crown is received, the first system switches the watch-face interface 41 to an application list interface 42. The application list interface 42 displays an application icon of each application.

At block 302, the first system sends an application starting message to the second system in response to a selection operation of a first application in the application list interface. The first application is an application run by the second system.

For each application displayed in the application list interface, the user may trigger the application through the selecting operation. The selection operation may be a click operation, a long-pressing operation, a pressing operation, etc., which is not limited herein.

Since the application selected by the user may be run by the first system or by the second system, the first system needs to determine which system runs the selected application. In a possible embodiment, when it is determined that the selected first application is run by the second system, the first system sends the application starting message to the second system, so as to instruct the second system to perform system switching and run the first application.

In a possible embodiment, each application in the application list interface is correspondingly arranged with an operating system identifier, so as to enable the first system to distinguish the application run by the first system and the application run by the second system. The operating system identifier is configured to represent a system running the application.

In response to the selection operation of the first application in the application list interface, the first system obtains an operating system identifier corresponding to the first application. The operating system identifier is configured to represent the system running the application. In a case where the operating system identifier indicates that the first application is run by the second system, the first system sends the application starting message to the second system.

In some embodiments, the operating system identifier is set by the first or the second system, and is stored in a storage space of the first system.

In a possible embodiment, the first system sends the application starting message to the second system in a manner of a dual-core communication. The application starting message at least includes application starting data of the first application. In some embodiments, the application starting data is an application package name of the first application.

If the second system is in the sleep state, the first system needs to wake up the second system firstly. The first system may wake up the second system in a manner of sending an interrupt, which is not limited herein.

At block 303, the second system starts the first application and displays the application interface based on the application starting message.

In the wake-up state, the second system determines the first application to be started based on the application starting message, so as to start the first application and display the application interface of the first application.

In a possible embodiment, since a screen control authority of the electronic device is held in the first system when the application list interface is displayed, the second system needs to first obtain the screen control authority from the first system. Therefore, the application interface of the first application is displayed through the screen after obtaining the screen control authority.

In some embodiments, as illustrated in FIG. 4, when receiving the click operation on a weather application 421 in the application list interface 42, the first system sends the application starting message to the second system because the weather application 421 is an application run by a second system. The second system starts the weather application 421 and displays a weather application interface 43 based on the application starting message.

In some embodiments, the application list interface includes a fourth application run by the first system. In response to a selection operation of the fourth application in the application list interface, the first system starts the fourth application and displays the application interface without the need for system switching.

In some embodiments, as illustrated in FIG. 4, when receiving the click operation of a heart rate application 422 on the application list interface 42, the first system starts the heart rate application 422 and displays the heart rate measurement interface 44 because the heart-rate application 422 is run by the first system.

In conclusion, for the electronic device supporting dual systems, the user may start the application run by the first system or the second system through the application list interface. Therefore, in some embodiments of the present disclosure, the application list interface is displayed through the first system, and when the selection operation of the application run by the second system in the application list is received, the second system is switched to start the application and display the application interface. In this way, it may be possible to reduce an occurrence of switching from the first system to the second system when the application list interface needs to be displayed, so as to reduce a switching frequency between systems, thereby preventing the power consumption of the device from increasing due to the frequent system switching.

In some embodiments, displaying, by the first system, the application list interface, includes: obtaining, by the first system, a stored application identifier and stored application layout information of at least one application, where the application layout information is configured to represent a layout manner of each application identifier on the application list interface; and displaying, by the first system, the application list interface based on the application identifier and the application layout information.

In some embodiments, the interface display method further includes: updating, by the first system, the application list interface in response to a layout editing operation of a second application in the application list interface, where the second application is run by the first system or the second system; and updating, by the first system, the application layout information.

In some embodiments, the interface display method further includes: updating, by the first system, the application list interface in response to an uninstallation operation of a third application in the application list interface, where the third application is run by the first system or the second system; and deleting, by the first system, the application identifier corresponding to the third application and updating, by the first system, the application layout information.

In some embodiments, in a case where the third application is run by the second system, the interface display method further includes: sending, by the first system, an application uninstallation message to the second system; and uninstalling, by the second system, the third application based on the application uninstallation message.

In some embodiments, the interface display method further includes: sending, by the second system, an application list update message to the first system, where the application list update message includes at least one of an application installation message, the application uninstallation message, and an application update message; and updating, by the first system, the stored application identifier and the stored application layout information based on the application list update message.

In some embodiments, the interface display method further includes: in response to a return operation, sending, by the second system, an interface switching message to the first system based on the return operation; and obtaining, by the first system, a screen control authority from the second system, and displaying, by the first system, a target interface based on the interface switching message, where the target interface is a system main interface of the first system or the application list interface.

In some embodiments, in response to the return operation, sending, by the second system, the interface switching message to the first system based on the return operation, includes: in response to a first return operation, sending, by the second system, a first interface switching message to the first system based on the first return operation, where the first interface switching message is configured to indicate the first system to switch to display the system main interface; and in response to a second return operation, sending, by the second system, a second interface switching message to the first system based on the second return operation, where the second interface switching message is configured to indicate the first system to switch to display the application list interface.

In some embodiments, after sending, by the second system, the first interface switching message to the first system based on the first return operation, the interface display method further includes: switching the second system from a wake-up state to a sleep state. After sending, by the second system, the second interface switching message to the first system based on the second return operation, the interface display method further includes: remaining, by the second system, the wake-up state during a wake hold period; and switching the second system from the wake-up state to the sleep state in a case where the wake hold period is reached and the application starting message is not received.

In some embodiments, sending, by the first system, the application starting message to the second system in response to the selection operation of the first application in the application list interface, includes: obtaining, by the first system, an operating system identifier corresponding to the first application in response to the selection operation of the first application in the application list interface, where the operating system identifier is configured to represent a system running the application; and sending, by the first system, the application starting message to the second system in a case where the operating system identifier indicates that the first application is run by the second system.

In some embodiments, the interface display method further includes: starting, by the first system, a fourth application and displaying, by the first system, an application interface in response to a selection operation of the fourth application in the application list interface, where the fourth application is run by the first system.

In some embodiments, the operating power consumption of the first system is lower than that of the second system.

When the first system is configured to display the system main interface, the application interface (the application is run by the first system), and the application list interface, and the second system is configured to display the application interface (the application is run by the second system), a system state of each system may include the following situations during a switching interface process.

1. When the electronic device changes from screen-off to screen-on, the first system is configured to control a screen to display the system main interface, and the second system is in the sleep state.

2. When the switching operation of the main interface is received, the first system switches the system main interface (such as switching the watch-face interface of the smartwatch), and the second system is in the sleep state.

3. The first system is configured to control the screen to display the application interface. When a starting operation of the main interface is received, the first system is configured to control the screen to display the system main interface, and the second system is in the sleep state.

4. The second system is configured to control the screen to display the application interface. When the starting operation of the main interface is received, the first system is configured to control the screen to display the system main interface, and the second system is switched to the sleep state.

5. The first system is configured to control the screen to display the system main interface. When a starting operation or a list starting operation of the application in the first system is received, the first system is configured to control the screen to display the application interface or the application list interface, and the second system is in the sleep state.

6. The first system control screen is configured to control the screen to display the system main interface. When a starting operation of the application in the second system, the first system is configured to wake up the second system, and the second system is configured to control the screen to display the application interface.

7. The first system is configured to control the screen to display the system main interface. When the list starting operation is received, the first system is configured to display the application list interface, and the second system is in the sleep state.

8. The first system is configured to control the screen to display the application interface. When the list starting operation is received, the first system is configured to control the screen to display the application list interface, and the second system is in the sleep state.

9. The second system is configured to control the screen to display the application interface. When the list starting operation is received, the second system is switched to the first system. The first system is configured to control the screen to display the application list interface, and the second system is switched to the sleep state.

10. The first system is configured to control the screen to display the application list interface. When the starting operation of the application in the first system is received, the first system is configured to control the screen to display the application interface, and the second system is in the sleep state.

11. The first system is configured to control the screen to display the application list interface. When the starting operation of the application in the second system is received, the first system is configured to wake up the second system, and the second system is configured to control the screen to display the application interface.

From the foregoing situations, it may be seen that, when it is necessary to start the application run by the second system, the second system may be woken up by the first system and start the application. In this way, it may be possible to increase a running duration/period proportion of the first system during the running of the electronic device, so as to reduce the power consumption of the device and reduce frequent switching between systems.

In a possible embodiment, the first system obtains a stored application identifier and stored application layout information of at least one application during a process of displaying the application list, such that the application list interface is displayed based on the application identifier and the application layout information. The application layout information is configured to represent a layout manner of each application identifier on the application list interface.

In some embodiments, the application identifier and the application layout information are stored in a corresponding storage space of the first system, and are remained and updated by the first system.

In some embodiments, the application identifier may include an application icon, an application name, etc., which is not limited herein.

In some embodiments, the application layout information may include a display position and a display size of the application icon in the application list, a display font and a display size of the application name, etc. The specific content contained in the application layout information is not limited herein.

During a process of using the electronic device, the user may adjust a layout of the application in the application list interface according to the user's own needs, such as adjusting the display position of the application in the application list interface, and performing a list topping operation on a common application.

In a possible embodiment, the first system updates the application list interface in response to a layout editing operation of the second application in the application list interface. The second application is run by the first system or the second system. In addition, since the application contained in the application list interface has not changed after the layout editing operation, the first system only needs to update the application layout information.

In some embodiments, the layout editing operation includes an icon moving operation (such as long-pressing and dragging the application icon), a topping operation (such as long-pressing the application icon to call out an editing menu, and clicking a topping option in the editing menu), etc. The specific manner of the layout editing operation is not limited herein.

In some embodiments, as illustrated in FIG. 5, the first system displays an application list interface 51. When the long-pressing and dragging operation on a clock application icon 511 is received, and an end point of the long-pressing and dragging operation is located on a heart rate application icon 512, the first system swaps a display position of the clock application icon 511 and a display position of the heart rate application icon 512 in the application list interface 51, and updates layout information corresponding to the clock application icon 511 and the heart rate application icon 512 in the application layout information.

In addition to editing the layout of the application in the application list interface, the user may further uninstall the application in the application list interface according to needs. In a possible embodiment, the first system updates the application list interface in response to an uninstallation operation of a third application in the application list interface. The third application is run by the first system or the second system.

Due to a change in the application contained in the application list interface after a deletion operation, the first system needs to update the stored application identifier and the stored application layout information. In some embodiments, the first system deletes the application identifier corresponding to the third application and updates the application layout information.

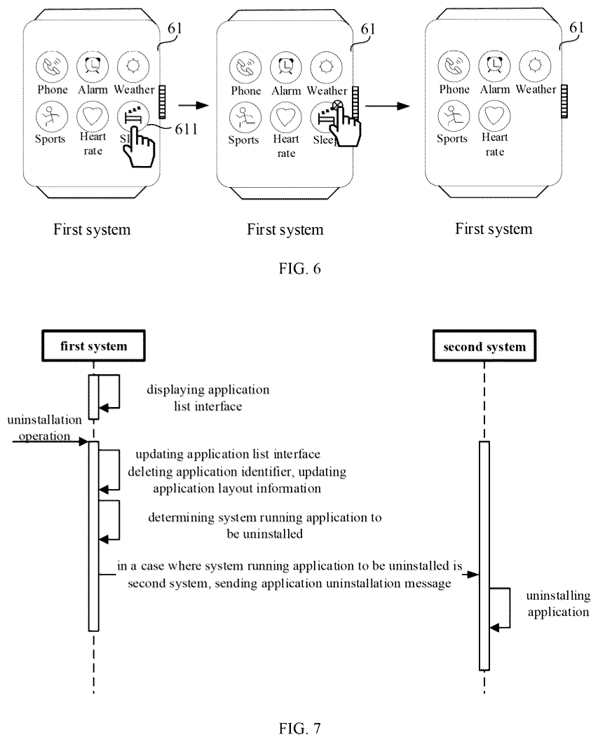

In some embodiments, as illustrated in FIG. 6, the first system displays an application list interface 61. When a long-pressing operation on a sleep application icon 611 is received, a deletion control is displayed on an upper right corner of the sleep application icon 611. When a click operation on the deletion control is received, the first system deletes the sleep application icon 611 from the application list interface 61 and deletes an application identifier and layout information corresponding to the sleep application.

In a possible embodiment, when the uninstallation operation of the third application is received by the first system, the first system determines a system running the third application based on an operating system identifier corresponding to the third application. When the third application is run by the first system, the first system deletes application data of the third application, so as to free up the storage space of the first system.

When the third application is run by the second system, as the relevant data of the third application is stored in a storage space corresponding to the second system, the first system further needs to notify the second system to uninstall the third application (the first system only deletes the application icon in the application list interface).

In a possible embodiment, when the third application is run by the second system, the first system sends an application uninstallation message to the second system, and the second system uninstalls the third application based on the application uninstallation message. In some embodiments, the application uninstallation message includes an application identifier of the third application.

In some embodiments, as for a moment when the first system sends the application uninstallation message, when the uninstallation operation is received by the first system and the second system is in the wake-up state, the first system sends the application uninstallation message to the second system (the second system receives the application uninstallation message and performs an application uninstallation in the background, and the first system still controls the screen display). When the uninstallation operation is received by the first system and the second system is in the sleep state, the first system sends the application uninstallation message to the second system when waking up the second system in a next time, so as to prevent the second system from being woken up frequently.

In some embodiments, as illustrated in FIG. 7, during a process where the first system displays the application list interface, when the uninstallation operation is received, the first system updates the application list interface based on the uninstallation operation (removing an application icon of an application to be uninstalled from the application list interface) and determines a system running the application to be uninstalled. When the application to be uninstalled is run by the second system, the first system sends an application uninstallation message to the second system. After receiving the application uninstallation message, the second system may perform the application uninstallation.

The uninstalling application is performed through the application list interface when the first system is running in the foreground. In addition, the second system may install a new application through a running application store, delete an installed application, or update an installed application when the second system is running in the foreground. In this case, in a possible embodiment, the second system sends an application list update message to the first system, so as to enable the application displayed in the application list interface to be updated synchronously. The application list update message includes at least one of an application installation message, the application uninstallation message, and the application update message. Correspondingly, the first system updates the stored application identifier and the stored application layout information based on the application list update message.

In some embodiments, the application installation message includes an application identifier of a newly installed application. The application uninstallation message includes an application identifier of the application to be uninstalled. The application update message includes an application identifier of an application to be updated.

In some embodiments, in response to the application installation operation (installation through the application store installation or installation based on an obtained application installation package), the second system sends the application installation message to the first system. The first system adds the application identifier based on the application installation message and updates the application layout information (at least adding layout information of the newly installed application).

In response to the application uninstallation operation (uninstallation through the application store or through an application management software), the second system sends the application uninstallation message to the first system. Based on the application uninstallation message, the first system deletes the application identifier of the application to be uninstalled and updating the application layout information (at least deleting the layout information of the application to be uninstalled).

In response to the application update operation (manually or automatically triggered by the user), the second system sends the application update message to the first system. The first system updates the application identifier based on the application update messages.

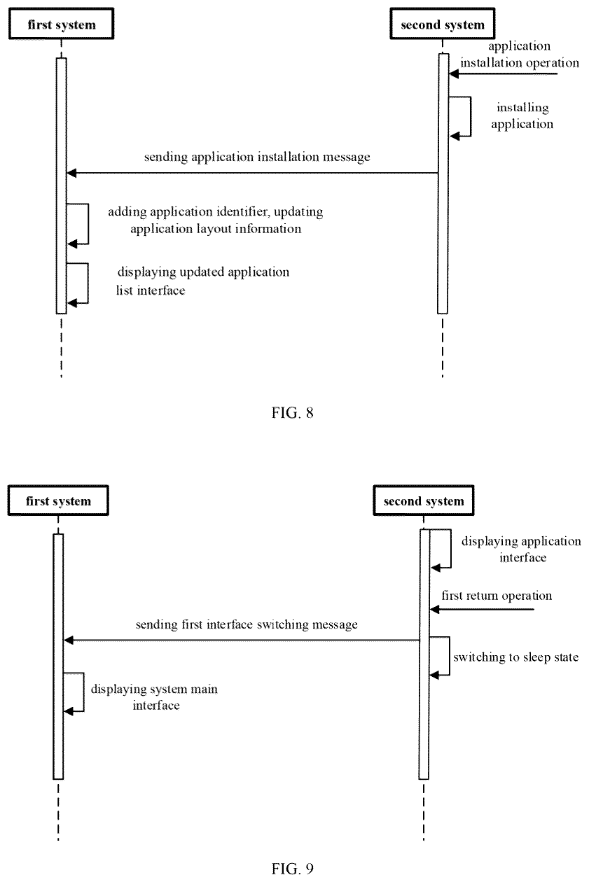

In some embodiments, as illustrated in FIG. 8, when the second system is running in the foreground and the application installation operation is received, the second system installs the application and sends the application installation message including the application identifier to the first system. After receiving the application installation message, the first system adds the application identifier and updates the application layout information. Subsequently, the first system may display the application list interface based on the updated application layout information and the application identifier.

In other possible embodiments, when the second system is in the wake-up state, in response to a language change operation, the second system sends a language update message to the first system, and the first system updates the stored application identifier based on the language update message. In some embodiments, when a system language is changed from Chinese to English, the second system sends the language update message including an English name of the application to the first system, so that the first system updates a stored Chinese name of the application to the English name of the application.

In other possible embodiments, when the second system is in the wake-up state, in response to a display mode change operation, the second system sends a display mode update message to the first system, and the first system updates the application layout information based on the display mode update message. The display mode update message is configured to indicate to update at least one of a font, a font size, a size of the application icon, and a view of the application icon (a list view or a grid view). In some embodiments, when the user switches the display mode to an elderly mode, the first system increases the size of the application icon and the font size of the application name based on the display mode change message sent by the second system.

After the first application is used, the user may switch the first system back to a foreground state through a return operation. In a possible embodiment, in response to the return operation, the second system sends an interface switching message to the first system based on the return operation. The interface switching message is configured to indicate the switching display of the target interface of the first system.

When the application interface of the first application is displayed, the screen control authority of the electronic device is held in the second system. Therefore, after receiving the interface switching message, the first system obtains the screen control authority from the second system and displays the target interface based on the interface switching message. The target interface is the main system interface of the first system or the application list interface. For example, when the electronic device is the smartwatch, the system main interface may be the watch-face interface.

Under different types of return operations, target interfaces displayed by the first system upon returning are different.

In some embodiments, in response to a first return operation, sending, by the second system, a first interface switching message to the first system based on the first return operation. The first interface switching message is configured to indicate the first system to switch to display the system main interface.

In a possible embodiment, the first interface switching message includes a first identifier. When the first identifier is identified by the first system, the first system switches to display the system main interface.

In an embodiment, when the electronic device is the smartwatch, the second system sends the first interface switching message to the first system when a screen coverage operation is received (that is, a palm is used to cover the screen, and the screen coverage operation may be identified by detecting the number of touch point coordinates).

In response to a second return operation, sending, by the second system, a second interface switching message to the first system based on the second return operation. The second interface switching message is configured to indicate the first system to switch to display the application list interface.

In a possible embodiment, the second return operation is different from the first return operation, and the second interface switching message includes a second identifier different from the first identifier. When the second identifier is identified by the first system, the first system switches to display the application list interface.

In an embodiment, when the electronic device is the smartwatch, the second system sends a second interface switching message to the first system when receiving the pressing operation on the watch crown.

In a possible embodiment, when the first system displays the target interface, the second system switches from the wake-up state to the sleep state, so as to reduce the power consumption. However, when the user triggers to switch the first system to display the application list interface through the second return operation, the user usually continues to choose to start other applications from the application list interface. If an application selected to be started subsequently is run by the second system, the second system needs to be woken up again, causing the second system to switch frequently between the sleep state and the wake state in a short time.

In a possible embodiment, after the second system sends the first interface switching message to the first system based on the first return operation, the second system is switched from the wake-up state to the sleep state, so as to prevent the second system from frequently switching state in a short time. After the user triggers to switch the first system to display the system main interface through the first return operation, the application run by the second system may not normally continue to start. Therefore, the second system is immediately switched to the sleep state after the second system sends a first interface switching message to the first system, thereby reducing the power consumption of the device.

In some embodiments, as illustrated in FIG. 9, when the second system displays the application interface, the second system sends the first interface switching message to the first system and is switched to the sleep state when the first return operation is received. The first system obtains the screen control authority from the second system and controls the screen to display the system main interface based on the first interface switching message.

In another possible embodiment, after the second system sends the second interface switching message to the first system based on the second return operation, the second system remains the wake-up state during a wake hold period. When the second system remains the wake-up state, the first system has the screen control authority of the device, and the second system is in a background running state. In a case where the wake hold period is reached and the application starting message sent by the first system is not received, the second system is switched from the wake-up state to the sleep state.

After the user triggers to switch the first system to display the application list interface through the second return operation, the user usually continues to choose to start the other applications. Therefore, the second system may be not immediately switched to the sleep state after sending the second interface switching message to the first system, but may remain the wake-up state during the wake hold period (such as Is, 2s, etc.). If the first system receives the selection operation from the application list interface during the wake hold period, and the selected application is run by the second system, the first system may send the application starting message to the second system. Since the second system remains in the wake-up state, the second system does not need to perform state switching and directly starts the application. In this way, on the one hand, it may be possible to prevent the second system form switching state frequently, and on the other hand, it may be possible to improve a starting speed of the application (since a process of switching from the sleep state to the wake-up state is omitted).

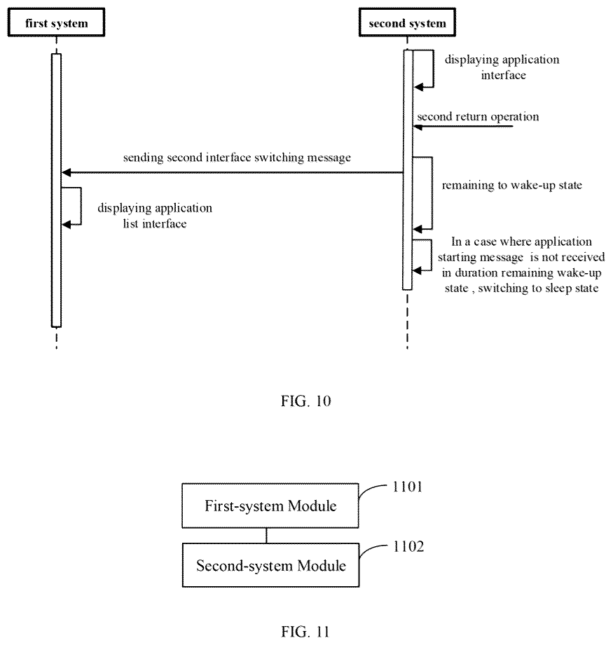

In some embodiments, as illustrated in FIG. 10, when the second system displays the application interface, the second system sends the second interface switching message to the first system when the second return operation is received, and the second system remains the wake-up state. The first system obtains the screen control authority from the second system based on the second interface switching message, and controls the screen to display the application list interface. If the application starting message sent by the first system is not received during a wake-up period, the second system is switched to the sleep state.

As illustrated in FIG. 11, FIG. 11 illustrates a structural block diagram of an interface display apparatus according to another embodiment of the present disclosure. The apparatus may be implemented as all or part of an electronic device by software, hardware, or a combination of both. The apparatus includes a first-system module 1101 and a second-system module 1102.

The first-system module 1101 is configured to display an application list interface in response to a list starting operation. The application list interface includes an application run by the first-system module 1101 and an application run by the second-system module 1102. The first-system module 1101 is further configured to send the application starting message to the second-system module 1102 in response to a selection operation of a first application in the application list interface. The first application is run by the second-system module 1102. The second-system module 1102 is configured to start the first application based on the application starting message and display the application interface.

In some embodiments, the first-system module 1101 is further configured to obtain a stored application identifier and stored application layout information of at least one application. The application layout information is configured to represent a layout manner of each application identifier on the application list interface. The first-system module 1101 is further configured to display the application list interface based on the application identifier and the application layout information.

In some embodiments, the first-system module 1101 is further configured to update the application list interface in response to a layout editing operation of a second application in the application list interface. The second application is run by the first-system module 1101 or the second-system module 1102. The first-system module 1101 is further configured to update the application layout information.

In some embodiments, the first-system module 1101 is further configured to update the application list interface in response to an uninstallation operation of a third application in the application list interface. The third application is run by the first-system module 1101 or the second-system module 1102. The first-system module 1101 is further configured to delete the application identifier corresponding to the third application and update the application layout information.

In some embodiments, in a case where the third application is run by the second-system module 1102, the first-system module 1101 is further configured to send an application uninstallation message to the second-system module 1102. The second-system module 1102 is further configured to uninstall the third application based on the application uninstallation message.

In some embodiments, the second-system module 1102 is further configured to send an application list update message to the first-system module 1101. The application list update message includes at least one of an application installation message, the application uninstallation message, and an application update message. The first-system module 1101 is further configured to update the stored application identifier and the stored application layout information based on the application list update message.

In some embodiments, in response to a return operation, the second-system module 1102 is further configured to send an interface switching message to the first-system module 1101 based on the return operation. The first-system module 1101 is further configured to obtain screen control authority from the second-system module 1102 and display a target interface based on the interface switching message. The target interface is a system main interface of the first-system module 1101 or the application list interface.

In some embodiments, in response to a first return operation, the second-system module 1102 is further configured to send a first interface switching message to the first-system module 1101 based on the first return operation. The first interface switching message is configured to indicate the first-system module 1101 to switch to display the system main interface. In response to a second return operation, the second-system module 1102 is further configured to send a second interface switching message to the first-system module 1101 based on the second return operation. The second interface switching message is configured to indicate the first-system module 1101 to switch to display the application list interface.

In some embodiments, the second-system module 1102 is further configured to switch from wake-up state to sleep state. The second-system module 1102 is further configured to remain the wake-up state during the wake hold period. The second-system module 1102 is further configured to switch from the wake-up state to the sleep state in a case where the wake hold period is reached and the application starting message is not received.

In some embodiments, the first-system module 1101 is further configured to obtain an operating system identifier corresponding to the first application in response to the selection operation of the first application in the application list interface. The operating system identifier is configured to represent a system running the application. The first-system module 1101 is further configured to send the application starting message to the second system in a case where the operating system identifier indicates that the first application is run by the second system.

In some embodiments, the first-system module 1101 is further configured to start a fourth application and displaying an application interface in response to a selection operation of a fourth application in the application list interface. The fourth application is run by the first-system module 1101.

In some embodiments, operating power consumption of the first-system module 1101 is lower than that of the second-system module 1102.

In conclusion, for the electronic device supporting dual systems, the user may start the application run by the first system or the second system through the application list interface. Therefore, in some embodiments of the present disclosure, the application list interface is displayed through the first system, and when the selection operation of the application run by the second system in the application list is received, the second system is switched to start the application and display the application interface. In this way, it may be possible to reduce an occurrence of switching from the first system to the second system when the application list interface needs to be displayed, so as to reduce a switching frequency between systems, thereby preventing the power consumption of the device from increasing due to the frequent system switching.

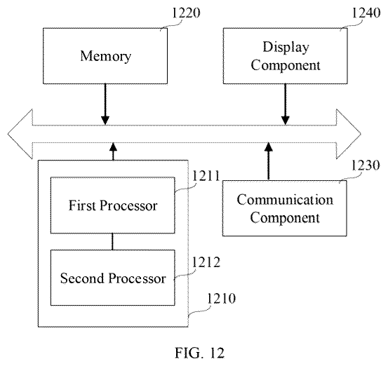

As illustrated in FIG. 12, FIG. 12 is a structural block diagram of an electronic device according to another embodiment of the present disclosure. The electronic device in some embodiments of the present disclosure may include one or more of the following components: a processor 1210 and a memory 1220.

In some embodiments, the processor 1210 at least includes a first processor 1211 and a second processor 1212. The first processor 1211 is configured to run the first system, and the second processor 1212 is configured to run the second system. The first processor 1211 has power consumption lower than the second processor 1212, and the first processor 1211 has a performance lower than the second processor 1212. The processor 1210 is configured to connect to each part of the whole electronic device via various interfaces and lines, to execute various functions of the electronic device and process data by running or executing an instruction, a program, a code set, or an instruction set that are all stored in the memory 1220 and invoking data stored in the memory 1220. Optionally, the processor 1210 may be implemented by using at least one hardware form of a digital signal processing (DSP), a field-programmable gate array (FPGA), or a programmable logic array (PLA). The processor 1210 may integrate one or any combination of a CPU, a graphic processing unit (GPU), a neural-network processing unit (NPU), a modem, or the like. The CPU is mainly configured to process an operating system, a UI, an application program, or the like. The GPU is configured to render and draw content required to be displayed on the TP. The NPU is configured to realize an artificial intelligence (AI) function. The modem is configured to process wireless communication. It should be understood that the modem may also not be integrated into the processor 1210 and may be implemented via a chip separately.

The memory 1220 may include the RAM or the ROM. Optionally, the memory 1220 may include a non-transitory computer-readable storage medium. The memory 1220 is configured to store an instruction, a program, a code, a code set, or an instruction set. The memory 1220 may include a program storage area and a data storage area. The program storage area is configured to store instructions for implementing the operating system, instructions for implementing at least one function (such as a touch control function, a sound playing function, an image playing function, or the like), instructions for implementing the above embodiments, or the like. The data storage area is configured to store data (such as audio data, phonebooks, or the like) created according to the usage of the wearable device.

The electronic device in embodiments of the present disclosure further includes a communication component 1230 and a display component 1240. The communication component 1230 may be a Bluetooth component, a wireless fidelity (Wi-Fi) component, a near field communication (NFC) component, or the like, and is configured to communicate with an external device (a server or other terminal devices) via a wired network or a wireless network. The display component 1240 is configured to display the GUI and/or receive a user interaction operation.

In addition, those skilled in the art can understand that the structure of the electronic device illustrated in the foregoing figures does not constitute any limitation on the electronic device. The electronic device may include more or fewer components than illustrated or may combine certain components or have different configurations or arrangements of components. For example, the electronic device further includes components such as a radio frequency (RF) circuit, an input unit, a sensor, an audio circuit, a loudspeaker, a microphone, a power supply, or the like, which are not described herein again.

A computer-readable storage medium is further provided in embodiments of the present disclosure. The storage medium store at least one program, and the at least one program is configured to be executed by the processor to perform the interface display method as described in the foregoing embodiments.

A computer program product or computer program is further provided in embodiments of the present disclosure. The computer program product or computer program includes a computer instruction stored in a computer-readable storage medium. The computer instruction is configured to be read by the processor of the electronic device from the computer-readable storage medium, and the computer instruction, when executed by the processor, causes a terminal to perform the interface display method as described in the foregoing embodiments.

Those skilled in the art should understand that in one or more of the above embodiments, the functions described in embodiments of the present disclosure may be implemented by any one or any combination of a hardware, a software, or a firmware. When implemented by software, functions may be stored in the computer-readable medium or transmitted as one or more instructions or codes in the computer-readable medium. The computer-readable medium includes a computer storage medium and a communication medium. The communication medium includes any medium that facilitates the transfer of a computer program from one place to another place. The storage medium may be any available medium that can be accessed by a general-purpose computer or a special-purpose computer.

The above are only optional embodiments of the present disclosure and are not intended to limit the scope of protection of the present disclosure, any modification, equivalent arrangements, and improvement made within the spirit and principles of the present disclosure shall be included in the scope of protection of the present disclosure.

1. An interface display method applicable to an electronic device, the electronic device supporting running of a first system and a second system, and the method comprising:
displaying, by the first system, an application list interface in response to a list starting operation, wherein the application list interface comprises an application run by the first system and an application run by the second system;
sending, by the first system, an application starting message to the second system in response to a selection operation of a first application in the application list interface, wherein the first application is run by the second system; and
starting, by the second system, the first application and displaying, by the second system, an application interface based on the application starting message.

2. The method as claimed in claim 1, wherein displaying, by the first system, the application list interface, comprises:
obtaining, by the first system, a stored application identifier and stored application layout information of at least one application, wherein the application layout information is configured to represent a layout manner of each application identifier on the application list interface; and
displaying, by the first system, the application list interface based on the application identifier and the application layout information.

3-5. (canceled)

6. The method as claimed in claim 2, further comprising:
sending, by the second system, an application list update message to the first system, wherein the application list update message comprises at least one of an application installation message, an application uninstallation message, and an application update message; and
updating, by the first system, the stored application identifier and the stored application layout information based on the application list update message.

7. The method as claimed in claim 1, further comprising:
in response to a return operation, sending, by the second system, an interface switching message to the first system based on the return operation; and
obtaining, by the first system, a screen control authority from the second system, and displaying, by the first system, a target interface based on the interface switching message, wherein the target interface is a system main interface of the first system or the application list interface.

8. The method as claimed in claim 7, wherein in response to the return operation, sending, by the second system, the interface switching message to the first system based on the return operation, comprises:
in response to a first return operation, sending, by the second system, a first interface switching message to the first system based on the first return operation, wherein the first interface switching message is configured to indicate the first system to switch to display the system main interface; and/or
in response to a second return operation, sending, by the second system, a second interface switching message to the first system based on the second return operation, wherein the second interface switching message is configured to indicate the first system to switch to display the application list interface.

9. The method as claimed in claim 8, wherein after sending, by the second system, the first interface switching message to the first system based on the first return operation, the method further comprises:
switching the second system from a wake-up state to a sleep state;
after sending, by the second system, the second interface switching message to the first system based on the second return operation, the method further comprises:
remaining, by the second system, the wake-up state during a wake hold period; and/or
switching the second system from the wake-up state to the sleep state in a case where the wake hold period is reached and the application starting message is not received.

10-11. (canceled)

12. The method as claimed in claim 1, wherein operating power consumption of the first system is lower than that of the second system.

13-17. (canceled)

18. An electronic device, comprising a processor and a memory, the memory storing at least one program, and the at least one program being configured to be executed by the processor to perform:
displaying, by the first system, an application list interface in response to a list starting operation, wherein the application list interface comprises an application run by the first system and an application run by the second system;
sending, by the first system, an application starting message to the second system in response to a selection operation of a first application in the application list interface, wherein the first application is run by the second system; and
starting, by the second system, the first application and displaying, by the second system, an application interface based on the application starting message.

19. A non-transitory computer-readable storage medium, the storage medium storing at least one program, the at least one program being configured to be executed by a processor to perform:
displaying, by the first system, an application list interface in response to a list starting operation, wherein the application list interface comprises an application run by the first system and an application run by the second system;
sending, by the first system, an application starting message to the second system in response to a selection operation of a first application in the application list interface, wherein the first application is run by the second system; and
starting, by the second system, the first application and displaying, by the second system, an application interface based on the application starting message.

20. (canceled)

21. The method as claimed in claim 1, further comprising:
controlling, by the second system, a screen to display the application interface run by the second system;
switching from the second system to the first system in response to receiving the list starting operation, controlling, by the first system, the screen to display the application list interface; remaining, by the second system, a wake-up state during a wake hold period; and
switching the second system from the wake-up state to a sleep state, in a case where the wake hold period is reached and the application starting message sent by the first system is not received.

22. The method as claimed in claim 1, further comprising:
controlling, by the first system, a screen to display the application interface run by the first system; and
controlling, by the first system, the screen to display a system main interface in response to receiving a starting operation of a main interface; or
wherein the method further comprises:
controlling, by the second system, a screen to display the application interface run by the second system; and
controlling, by the first system, the screen to display a system main interface in response to receiving a starting operation of a main interface.

23. The method as claimed in claim 1, further comprising:
during a process where the first system displays the system main interface, switching, by the first system, a system main interface to the application list interface in response to receiving the list starting operation; and/or
during a process where the first system runs the application, switching, by the first system, a currently displayed application interface to the application list interface in response to receiving the list starting operation.

24. The method as claimed in claim 1, further comprising:
during a process where the second system runs the application, switching from the second system to the first system in response to receiving the list starting operation, and displaying, by the first system, the application list interface.

25. The method as claimed in claim 1, wherein the electronic device is the smartwatch with a watch crown, the second system sends a second interface switching message to the first system in response to receiving a pressing operation on the watch crown, and the second interface switching message is configured to indicate the first system to switch to display the application list interface.

26. The method as claimed in claim 1,
wherein the method further comprises
controlling, by the first system, a screen to display the application interface run by the first system; and
controlling, by the first system, the screen to display the application list interface in response to receiving the list starting operation, and the second system being in a sleep state; or
wherein the method further comprises:
controlling, by the second system, a screen to display the application interface run by the second system; and
switching from the second system to the first system in response to receiving the list starting operation, controlling, by the first system, the screen to display the application list interface; and switching the second system to a sleep state.

27. The electronic device as claimed in claim 18, wherein the at least one program is further configured to be executed by the processor to perform:
in response to a return operation, sending, by the second system, an interface switching message to the first system based on the return operation; and
obtaining, by the first system, a screen control authority from the second system, and displaying, by the first system, a target interface based on the interface switching message, wherein the target interface is a system main interface or the application list interface of the first system.

28. The electronic device as claimed in claim 27, wherein in response to the return operation, sending, by the second system, the interface switching message to the first system based on the return operation, the at least one program is further configured to be executed by the processor to perform:
in response to a return operation, sending, by the second system, an interface switching message to the first system based on the return operation; and
obtaining, by the first system, a screen control authority from the second system, and displaying, by the first system, a target interface based on the interface switching message, wherein the target interface is a system main interface of the first system or the application list interface.

29. The electronic device as claimed in claim 28, wherein the at least one program is further configured to be executed by the processor to perform:
in response to a first return operation, sending, by the second system, a first interface switching message to the first system based on the first return operation, wherein the first interface switching message is configured to indicate the first system to switch to display the system main interface; and/or
in response to a second return operation, sending, by the second system, a second interface switching message to the first system based on the second return operation, wherein the second interface switching message is configured to indicate the first system to switch to display the application list interface.

30. The electronic device as claimed in claim 28, wherein the at least one program is further configured to be executed by the processor to perform:
waking up, by the first system, the second system before starting, by the first system, the application in the second system.

31. The electronic device as claimed in claim 28, wherein the at least one program is further configured to be executed by the processor to perform:
controlling, by the first system, a screen to display the application interface run by the first system; and
controlling, by the first system, the screen to display a system main interface in response to receiving a starting operation of a main interface; or
wherein the at least one program is further configured to be executed by the processor to perform:
controlling, by the second system, a screen to display the application interface run by the second system; and
controlling, by the first system, the screen to display a system main interface in response to receiving a starting operation of a main interface.
